(19) United States
(12) Patent Application Publication
(10) Pub. No.: US 2018/0115570 A1
(43) Pub. Date: Apr. 26, 2018

(54) SYSTEM AND METHOD FOR CATEGORIZING MALWARE

(71) Applicant: Vectra Networks, Inc., San Jose, CA (US)

(72) Inventor: Gunter Daniel Ollmann, Atlanta, GA (US)

(73) Assignee: Vectra Networks, Inc., San Jose, CA (US)

(21) Appl. No.: 15/794,935

(22) Filed: Oct. 26, 2017

Related U.S. Application Data
(60) Provisional application No. 62/413,374, filed on Oct. 26, 2016.

(51) Int. Cl. H04L 29/06

(52) U.S. Cl. CPC H04L 63/1416; G06F 17/30979; H04L 63/1425

(57) ABSTRACT

A system for categorizing malware threat names comprising a malware correlator and a frequency graph constructor engine based on a malware virus predicate. The malware correlator can categorize malware threat names based on a malware virus predicate or malware virus network behavior. The frequency graph constructor engine can construct a graphical representation of the malware threat family.

### CROSS REFERENCE TO RELATED APPLICATION(S)

This application claims the benefit of priority to U.S. Provisional Application No. 62/413,374, filed on Oct. 26, 2016, which is hereby incorporated by reference for all purposes in its entirety.

### BACKGROUND

In recent years, it has been increasingly difficult to distil an appropriate or common name for observed malware threats. For several decades, competing vendors of anti-virus or anti-malware products have pursued a diverse range of detection strategies. The competitive nature of the business has resulted in situations where malware and viruses may be assigned unique names by the first vendors to uncover the threat while other vendors, operating independently, discover and name the threat differently. In addition, with the growing use of behavioral detection systems, malware and viruses may be temporarily assigned dynamically generated descriptive names for a period of time prior to the vendor classifying the threat as either a previously known and labeled malware or virus family, or result in the creation of a new malware or virus family name.

As a consequence of the diverse and continuously changing landscape for malware and virus naming, it is often very difficult for a human to distil an appropriate or common name for an observed threat. A user's perspective and enumeration of a threat may also differ considerably depending on which vendor's antivirus products an organization employs and what third party systems they query for malware information.

Customers that use multiple antivirus products may also want to know the malware name for a few different reasons. Vendor customers may want to know what the name of the malware is so they can go to a different antivirus or malware to check to see if they have a signature that will block the particular malware. Another reason for choosing a correct name is for analysts who wish to do research on the malware.

The problem to be solved is therefore rooted in technological limitations of the legacy approaches. Improved techniques, in particular improved application of technology, are needed to address the problems that arise when the same malware and viruses are labeled different or temporary names. What is needed is a technique or techniques that effectively pools and enumerates the multitude of malware and virus names into a single human digestible and actionable framework.

### SUMMARY

The disclosed embodiments provide a system for categorizing malware into a single actionable framework. In some embodiments, the system will parse multiple vendor names and descriptive formats of a specific threat and construct a graphical representation of word or name frequency for the purpose of aiding a user in identifying the most appropriate and commonly used name for a threat.

In some embodiments, the system will query a malware database with a malware virus predicate such as a unique hash value or malware name to find malware names associated with the predicate. A malware correlator analyzes and generates families of malware threats by correlating malware data. A frequency graph constructor engine will construct a graphical representation of word or name frequency, this permits a user to visually identify the most appropriate and commonly used names for a threat.

In some embodiments, the system will query a malware database with malware network behavior to find unique hash values associated with the malware network behavior predicate.

Other additional objects, features, and advantages of the invention are described in the detailed description, figures, and claims.

### BRIEF DESCRIPTION OF THE DRAWINGS

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a system for categorizing malware threats according to some embodiments of the invention.

FIG. 2 shows a flowchart of an approach to categorize malware threats according to some embodiments of the invention.

FIG. 3 shows a system for gathering raw data for malware threats from different antivirus products into a malware database according to some embodiments of the invention.

FIG. 4A-C shows an approach to categorize malware threats based on a malware predicate according to some embodiments of the invention.

FIG. 5 shows a flowchart of an approach to collect malware names resulting from single malware predicate query according to some embodiments of the invention.

FIG. 6 shows a system for gathering raw data for malware threats based on malware network behavior from different antivirus products into a malware database according to some embodiments of the invention.

FIG. 7 shows a flowchart for gathering raw network behavior data for malware into a malware database according to some embodiments of the invention.

FIGS. 8A-D shows a system for categorizing malware threats based on malware network behavior according to some embodiments of the invention.

FIG. 9 illustrates a frequency graph according to some embodiments of the invention.

FIG. 10 illustrates a frequency graph represented as a word cloud according to some embodiments of the invention.

FIG. 11 is a block diagram of an illustrative computing system suitable for implementing an embodiment of the present invention for categorizing malware threats.

### DETAILED DESCRIPTION

The present invention is directed to a method, system, and computer program product for categorizing malware threats. Other objects, features, and advantages of the invention are described in the detailed description, figures, and claims.

Various embodiments of the methods, systems, and articles of manufacture will now be described in detail with reference to the drawings, which are provided as illustrative examples of the invention so as to enable those skilled in the art to practice the invention. Notably, the figures and the examples below are not meant to limit the scope of the present invention. Where certain elements of the present invention can be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, the present invention encompasses present and future known equivalents to the components referred to herein by way of illustration.

Before describing the examples illustratively depicted in the figures, a general introduction is provided for better understanding. In some embodiments, a malware correlator system may be implemented to pool and enumerate the multitude of malware and virus names into a single human digestible and actionable framework for the purpose of aiding a user in identifying the most appropriate and commonly used name for a malware threat. In some embodiments, a malware correlator system may parse multiple vendor names and descriptive formats of a specific threat. In some embodiments, a malware database will collect multiple malware names or employ third-party systems for malware vendor names and information. In some embodiments, the malware correlator system will output a malware name frequency graph (e.g., word cloud). The term “virus” and “malware” are used interchangeability throughout this specification.

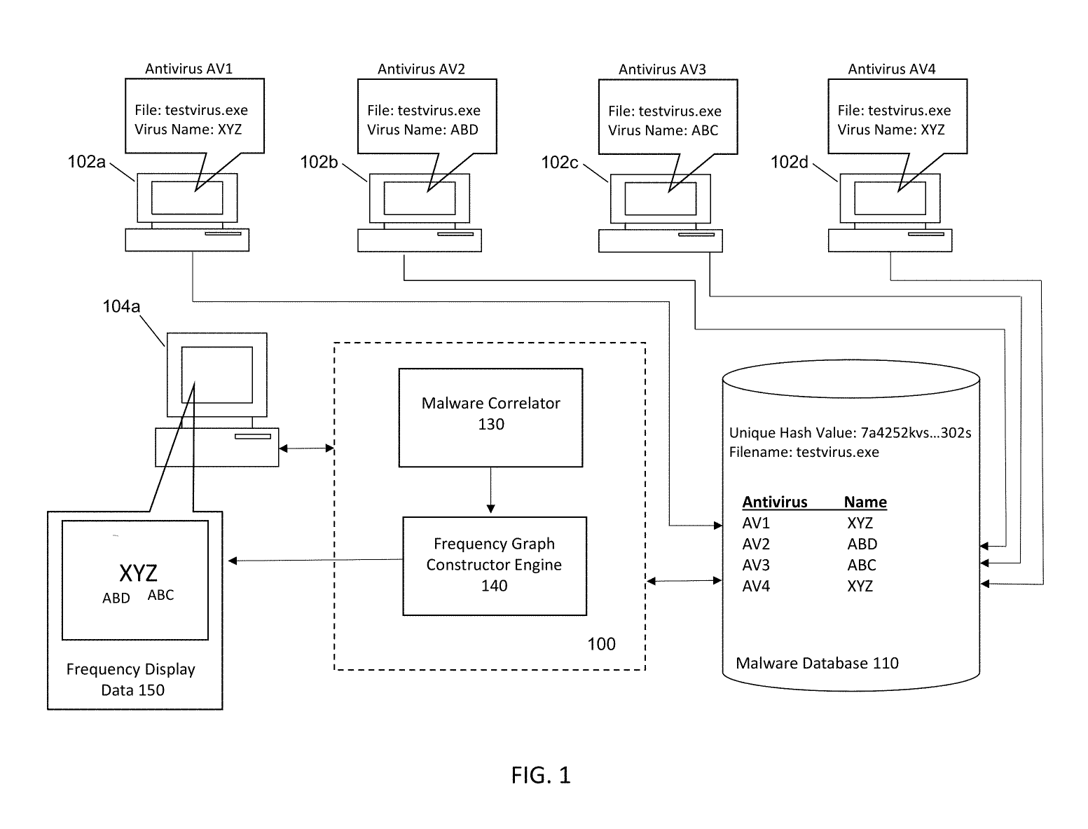

FIG. 1 illustrates an example environment 100 for categorizing malware names, as according to some embodiments. There, a malware correlator module 100 may consist of a malware correlator 130 and a frequency graph constructor engine 140. A malware correlator 130 may collect malware data resulting from querying a malware database 110 with a malware virus predicate (e.g., unique hash value, SHA1).

In some embodiments, the system gathers raw data for malware analyzed independently by different antivirus products (e.g., 102a, 102b, 102c, and 102d) into the Malware Database 110. Antivirus products work independently, so the antivirus products may assign unique names when they discover a new malware sample. This results in multiple product having different names for the same virus depending on what antivirus product a user uses. The system can also query a third-party system for malware raw data. As such, depending on which vendor's products an organization employs and what third-party systems they query for malware raw data their perspective and enumeration of a malware can differ considerably.

In some embodiments, if the Malware Database 110 contains malware names associated with the malware virus predicate, the Malware Correlator 130 may determine and generate families of malware threats corresponding to the malware virus predicate. In some embodiments, the Frequency Graph Constructor Engine 140 takes the correlated malware data and constructs a graphical representation of word or name frequency.

In some embodiments, a user computer 104a may be used to control the Malware Correlator 130 and Frequency Graph Constructor Engine 140. The user computer 104a comprises a display device, such a display monitor, for displaying a user interface to users at the user station. The user station 104a also comprises one or more input devices for the user to provide operational control over the activities of the system 100, such as a mouse of keyboard to manipulate a pointing object to generate user inputs to the system 100.

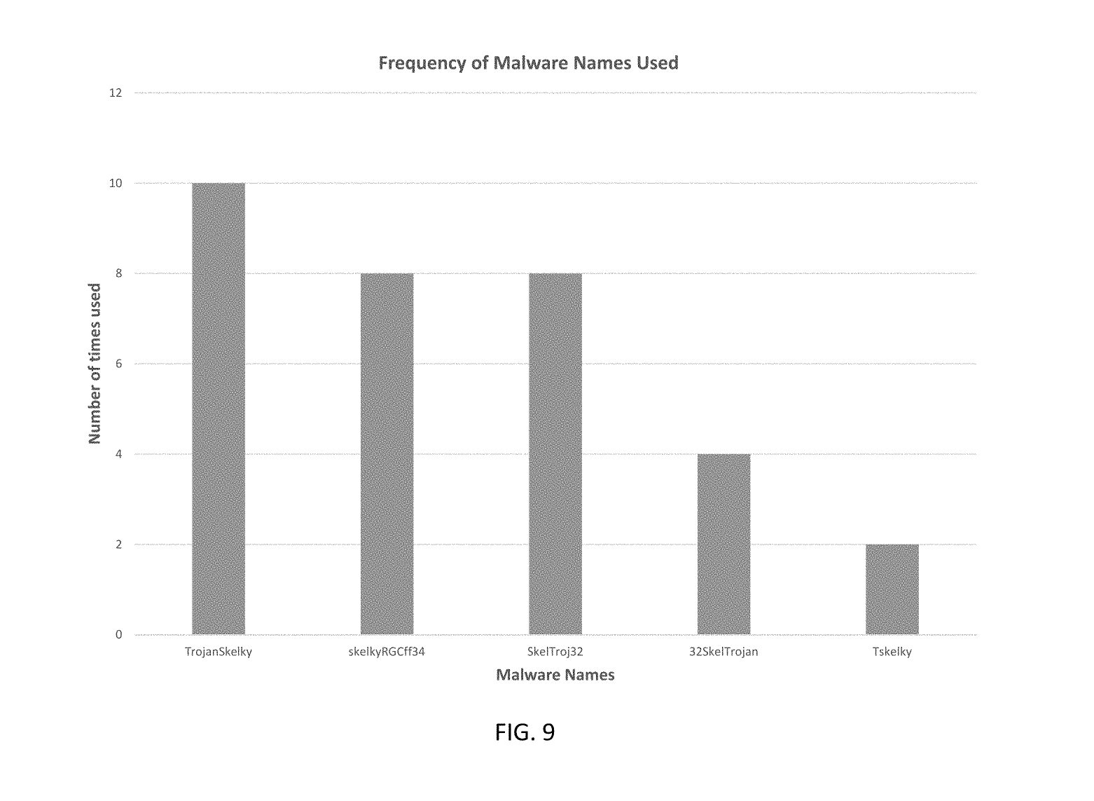

After the Frequency Graph Constructor Engine 140 operates on the correlated malware, the user computer 104a may request the Frequency Graph Constructor Engine 140 to generate Frequency Display Data 150. The Frequency Graph Constructor Engine 140 generates the content that is visually displayed to the user at user station 104a. This content includes, for example, the frequency graph shown in FIG. 9.

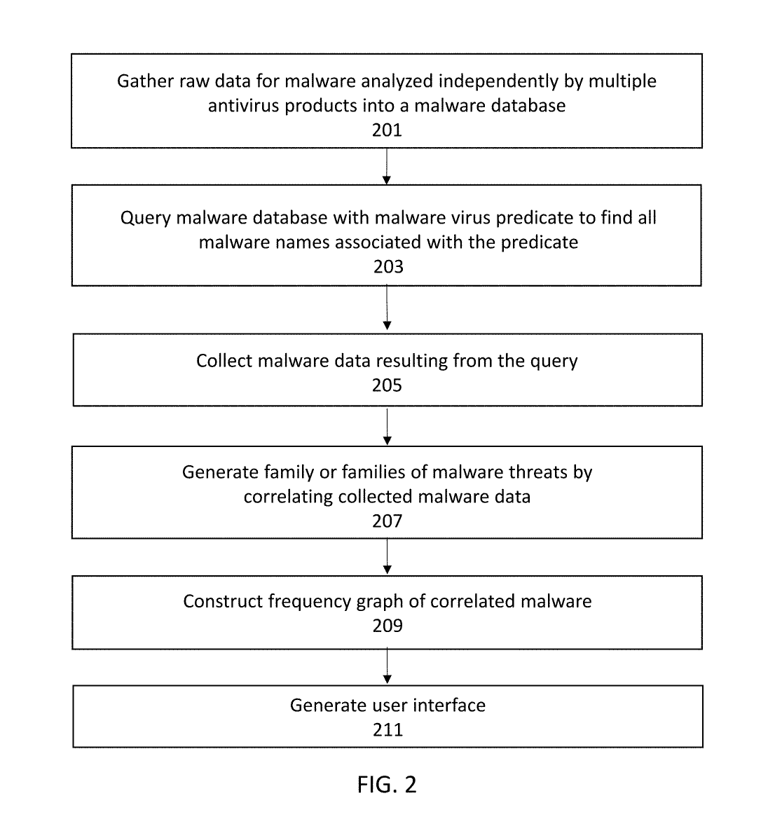

FIG. 2 shows a flowchart for an approach for categorizing malware, as according to some embodiments. In some embodiments, the malware virus predicate may be a unique hash value, or a Secure Hash Algorithm 1 (SHA-1). At 201, the system 100 gathers raw data for malware analyzed independently by multiple antivirus products into the Malware Database 110. At 203, the system queries the Malware Database 110 with a malware virus predicate to find the malware names associated with the predicate. For example, if the system queries the Malware Database 110 with a malware virus predicate of a unique hash value, the Malware Database 110 will generate a list of malware names used by a different antivirus company with the same unique hash value. A single malware unique hash value may yield multiple malware and virus names, from multiple anti-virus and anti-malware vendors. The names for the single malware unique hash may also have changed over a period of time.

At 205, the list of malware names resulting from the query will be collected by the Malware Correlator 130. Once collected, the Malware Correlator 130 will correlate and generate families of malware threats. At 207, the Malware Correlator 130 is controlled by user control signals from the user computer 104 to generate a family or families of malware threats by correlating the collected malware data. In some embodiments, the list of correlated malware or family or families of malware threats can be stored into a database in a computer readable storage device. The computer readable storage device comprises any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

At 209, once the malware has been correlated, the Frequency Graph Constructor Engine 140 constructs a graphical representation of word or name frequency for the purpose of aiding a user in identifying the most appropriate and commonly used name for a threat. In some embodiments, the Frequency Graph Constructor Engine 140 is controlled by user control signals from the user computer 104a. In some embodiments, the user may want to construct a frequency graph or a “word cloud” graph to aid in quickly identifying the most appropriate and commonly used names for the threat. For example, a user may want to use a word cloud graph to visually reveal which malware names are more frequently used without understanding the technicalities of how a family of malware threats was generated.

At 211, the Frequency Graph Constructor Engine 140 will generate a Frequency Display Data 150 for display to the user on the User Computer 104a. FIG. 9 illustrates an example frequency graph that can be used to display the results of categorizing malware names and families of malware names.

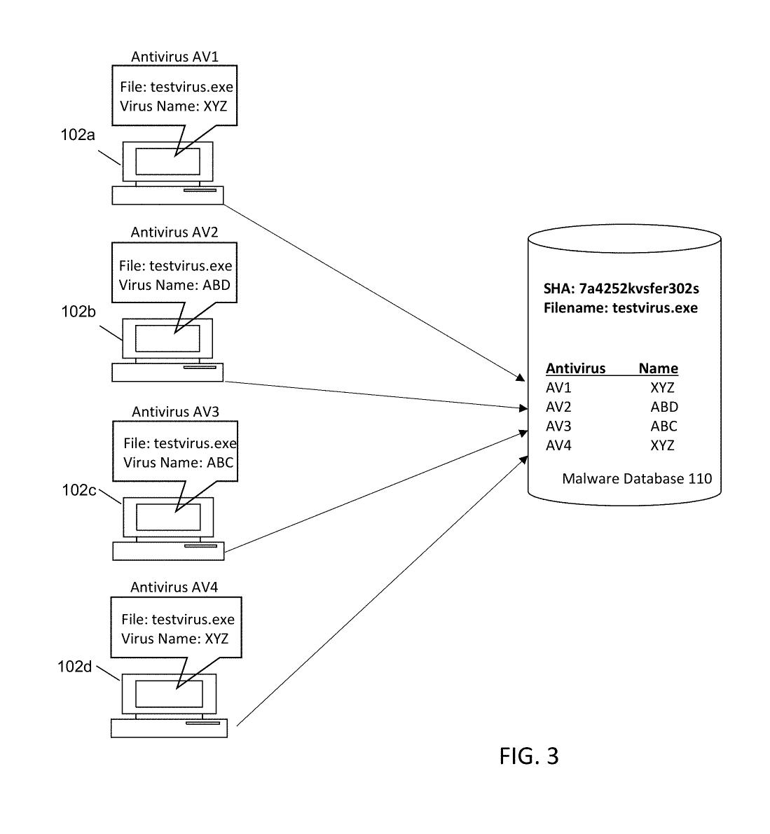

FIG. 3 shows an approach for gathering malware raw data for the malware database, as according to some embodiments. Different commercial antivirus and anti-malware vendors (e.g., 102a, 102b, 102c, and 102d) publish lists with their own malware names for a malware unique hash value. In some embodiments, the raw data for malware may be acquired through third-parties in bulk (e.g., downloadable archives), through querying APIs (e.g., lookup of a single or collection of malware unique hash values) or other means.

In other embodiments, the raw data for malware is manually collected from different antivirus products into a Malware Database 110.

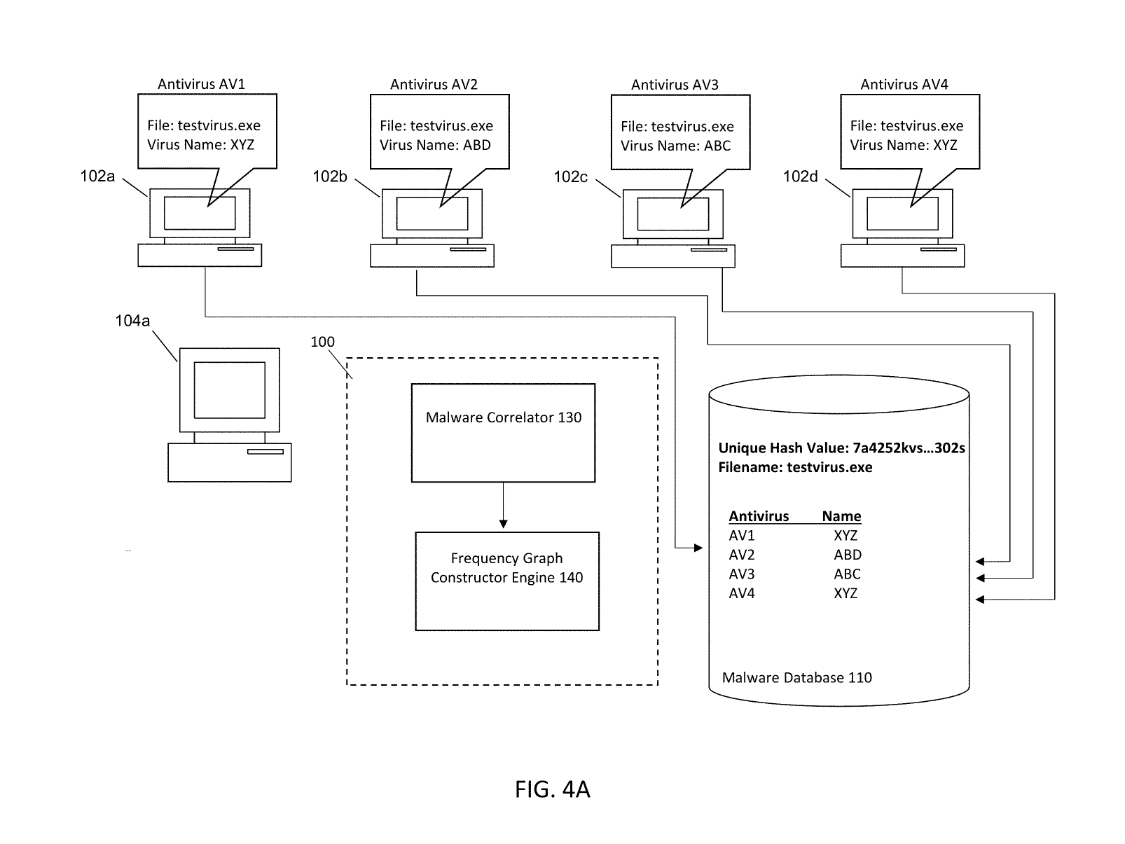

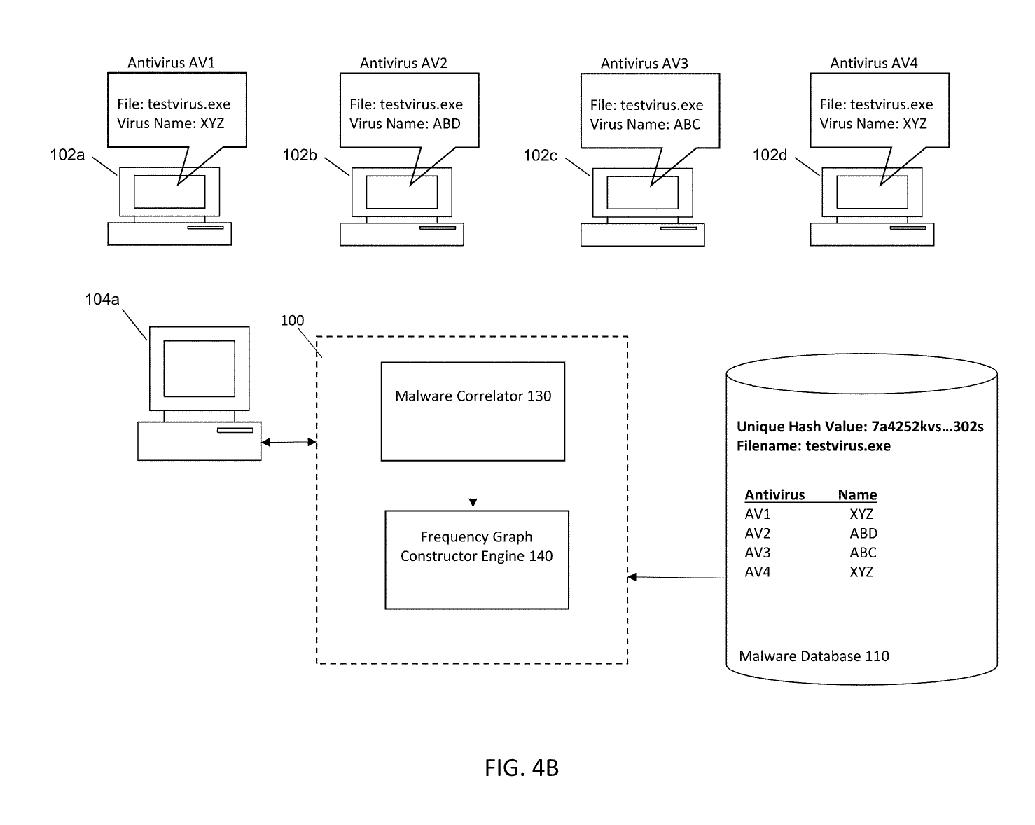

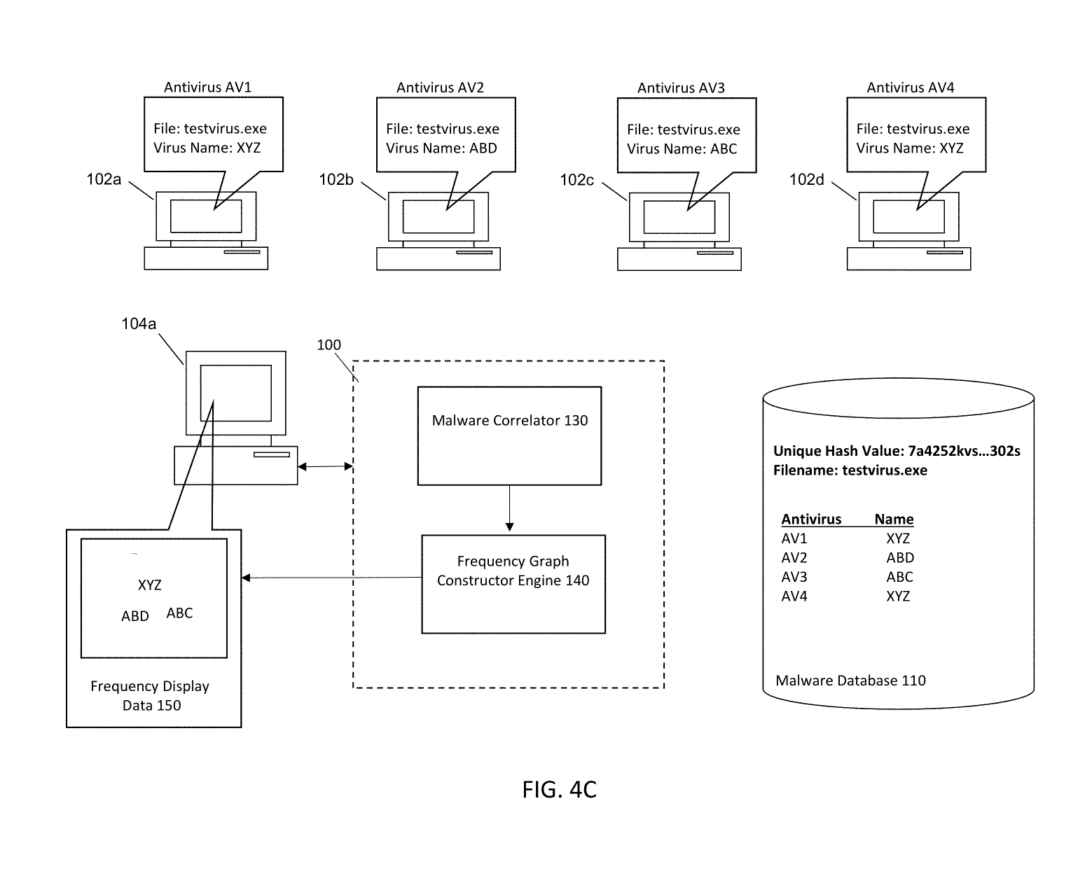

FIG. 4A-C illustrate diagrams showing components to categorize malware threats based on a single malware predicate according to some embodiments of the invention. Here, the interactions between the components and how they interact with one another are shown.

FIG. 4A illustrates the process of collecting raw malware database information from various antivirus programs. In this embodiment, Antivirus AV1 102a, Antivirus AV2 102b, Antivirus AV3 103c and Antivirus AV4 104d contain the same malware predicate hash value (e.g., as shown by the same testvirus.exe file) but a vendor may have a different name for the malware. In some cases, as shown by Antivirus AV1 102a and Antivirus AV4 102d, the antivirus products may already have the same name for the same virus. The Malware Database 110 collects the multiple virus names from a vendor and stores them in Malware Database 110. In some embodiments, the multiple virus names can be stored into a database in a computer readable storage device 110. The computer readable storage device could also be implemented as an electronic database system having storage on a persistent and/or non-persistent storage. In some embodiments, the malware single predicate can be a SHA1, or unique hash value.

FIG. 4B illustrates querying the malware database with malware virus predicate to find malware names associated with the predicate. The system may include a user computer 104a to request the malware correlator system 100 to query the Malware Database 101 to find malware names associated with the predicate. The Malware Correlator 130 collects raw malware data resulting from the query and generates families of malware threats by correlating the collected malware data.

FIG. 4C illustrates constructing a frequency graph of the correlated malware and generating a user interface for display. The user computer 104 may query the malware correlator system 100 to request the Frequency Graph Constructor Engine 140 to output a Frequency Display Data 150. The Malware Correlator 130 then sends families of malware threats to the Frequency Graph Constructor Engine 140 for constructing a graphical representation of the family of malware threat to display in computer 104a

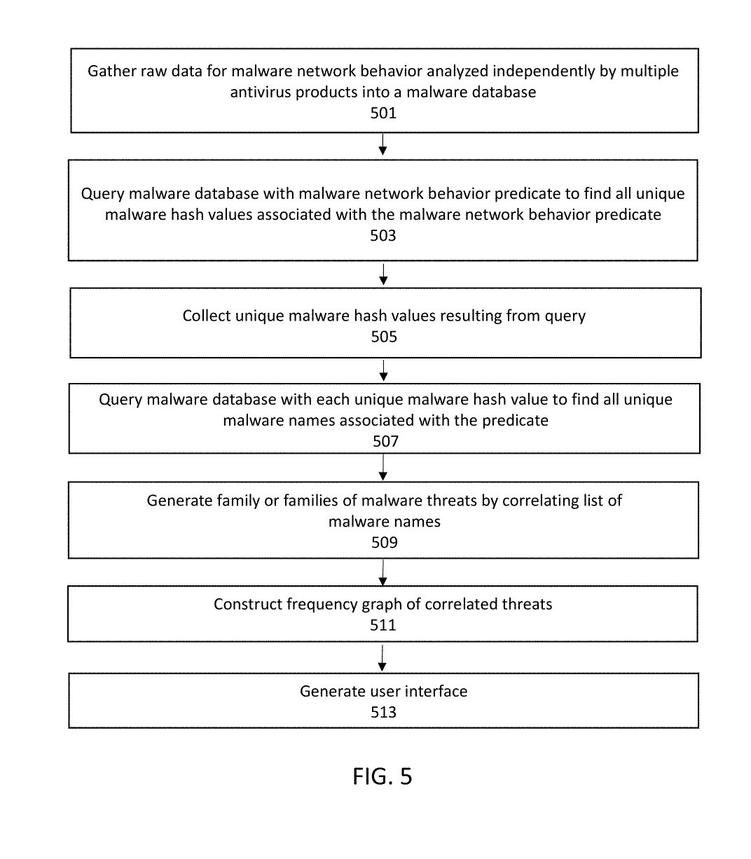

FIG. 5 shows a flowchart for an approach for categorizing malware virus based on malware network behavior, according to some embodiments. In some embodiments, the system may want to categorize malwares based on the malware's network behavior over a period of time. A malware's network behavior predicate may include an IP address destination, a domain name destination, or a peer-to-peer network behavior.

At 501, the system gathers raw data for malware analyzed independently by multiple antivirus products into a malware database. Given the malware network behavior predicate, a computing process identifies malware and viruses that have been previously observed to utilize or rely upon those same Internet addresses. At 503, the system queries Malware Database 110 with the malware network behavior predicate to find unique malware hash values associated with the same malware network behavior predicate. The Malware Correlator 130 collects unique malware hash values resulting from the database query at 505. In some embodiments, the list of collected unique malware hash values is stored into a database in a computer readable storage device. This list may comprise of multiple malware hashes associated with the malware network behavior predicate (e.g., IP address or domain name) over an extended period of time. The period of time may be pre-defined to limit query size and the volume of any returned results.

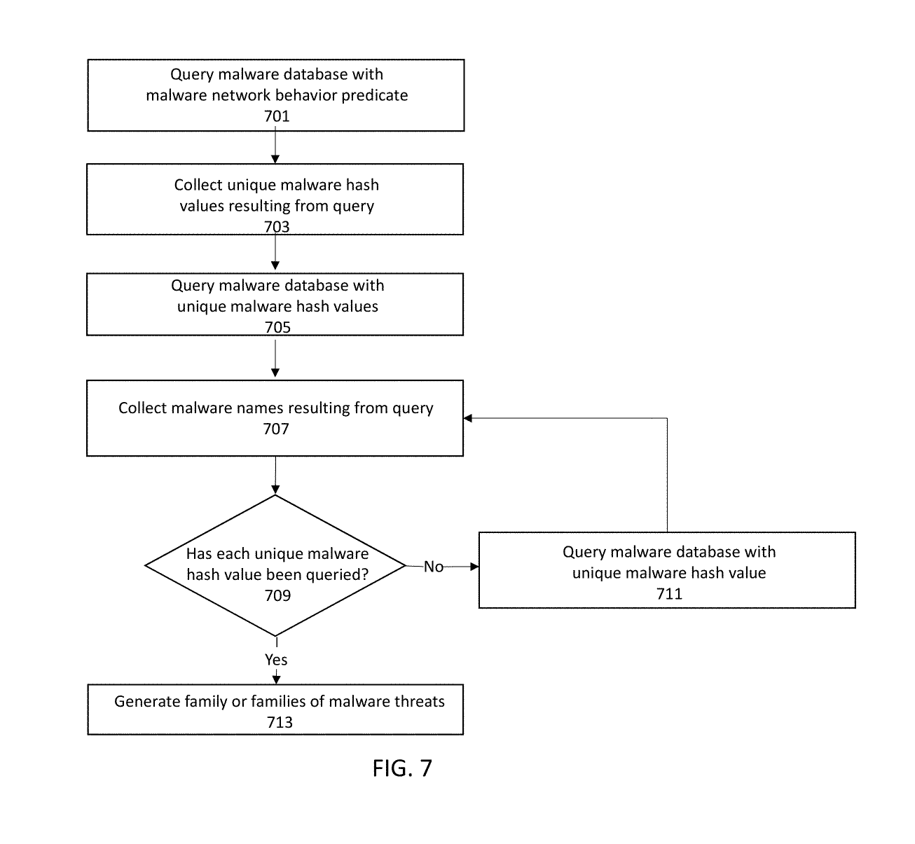

At 507, the Malware Correlator 130 will query Malware Database 110 again, but this time the query will be with a unique malware hash value to find unique malware names associated with a unique malware hash value collected from the same malware virus behavior predicate. This process is described in more detail in FIG. 7. At 509, the Malware Correlator 130 will generate a family of malware or families of malware by correlating the list of unique malware names. The list of collected malware family or families of malware threats is stored into a database in a computer readable storage device.

At 511, Frequency Graph Constructor Engine 140 will construct a frequency graph of correlated threats based on user control signals. At 513, the Frequency Graph Constructor Engine 140 will generate a user interface Frequency Display Data 150. The Frequency Graph Constructor Engine 140 generates the content that is visually displayed to the user at user station 104a. This content includes, for example, the frequency graph shown in FIG. 9.

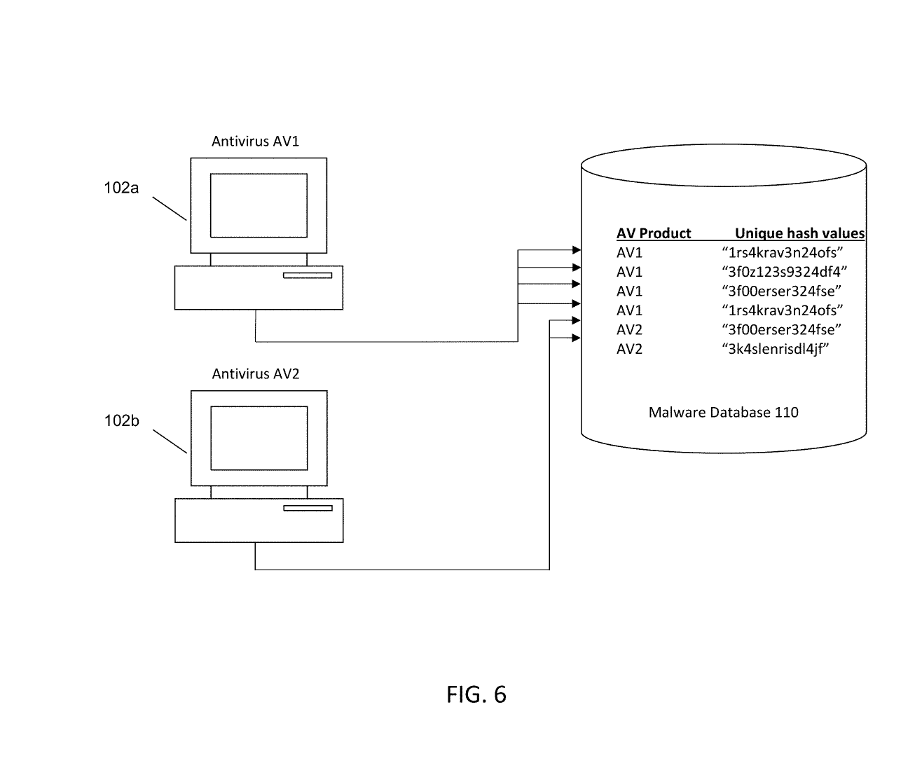

FIG. 6 shows an approach for generating raw data for the Malware Database 110, as according to some embodiments. Here, the malware network behavior predicate corresponds to a malware's network behavior over a given period of time. Given an IP destination address, a computing process (e.g., 102a, 102b) identifies malware and viruses that have been previously observed to utilize or rely upon the same IP destination address and a list of unique malware hashes or samples are provided for use. The initial IP address, domain name, or peer to peer network behavior may have been identified by observing network traffic within a monitored network over a given period of time, and associated with behaviors indicative of a class of threat. Alternatively, the IP address or domain name may come from external resources or be driven by a specific analysis query.

According to some other embodiments, the malware virus predicate may correspond to a malware's destination domain name or peer-to-peer network behavior.

FIG. 7 shows a flowchart approach for determining whether unique malware hash values have been queried, as according to some embodiments. At 701, the user queries the malware database with a malware network behavior predicate. At 703, a malware database or malware correlator collects a list of malware hash values resulting from the query.

At 705, the user queries a malware database with the unique malware hash value to extract a list of malware names for a unique hash value. A single malware hash may yield multiple malware and virus names from multiple anti-virus and anti-malware vendors. At 707, the malware name resulting from the query are collected in the malware correlator. At 709, the malware naming module determines whether a unique malware hash value has been queried to extract the list of malware names for that unique hash value. If not, then the user queries malware database with any unique malware hash value that has not been queried at 711. If yes, the malware correlator has collected malware names for a unique hash value from a queryable source and is ready to generate families of malware threats at 713.

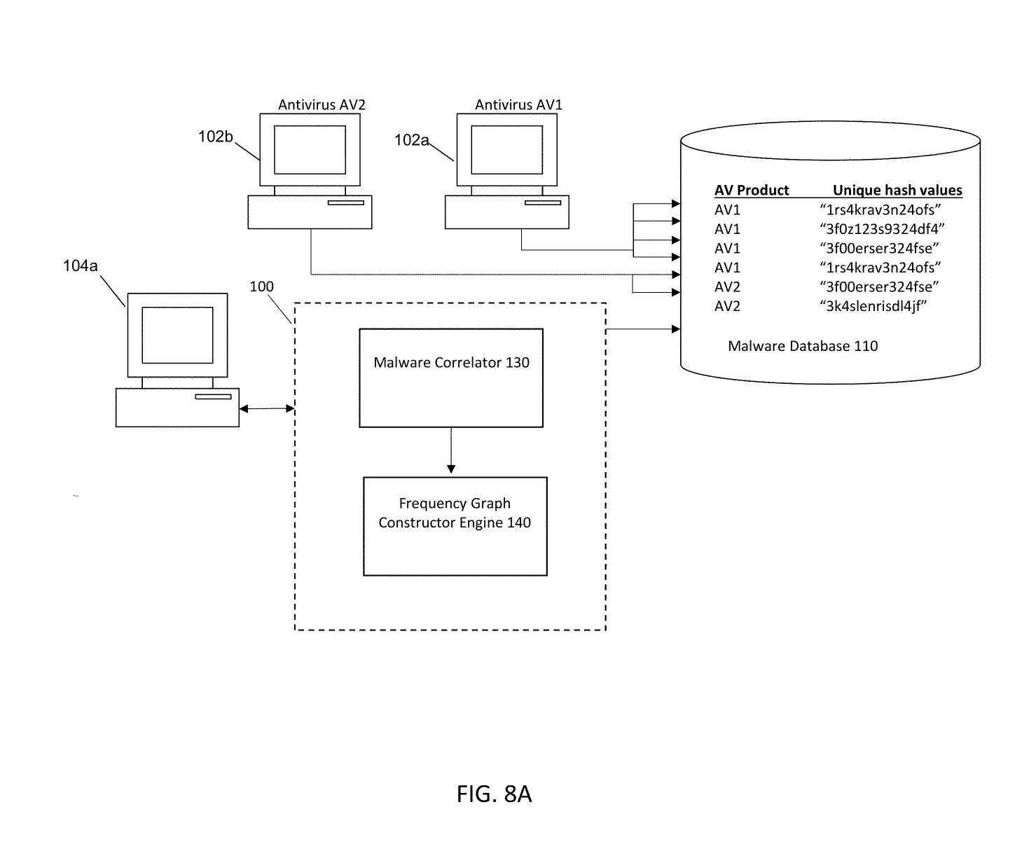

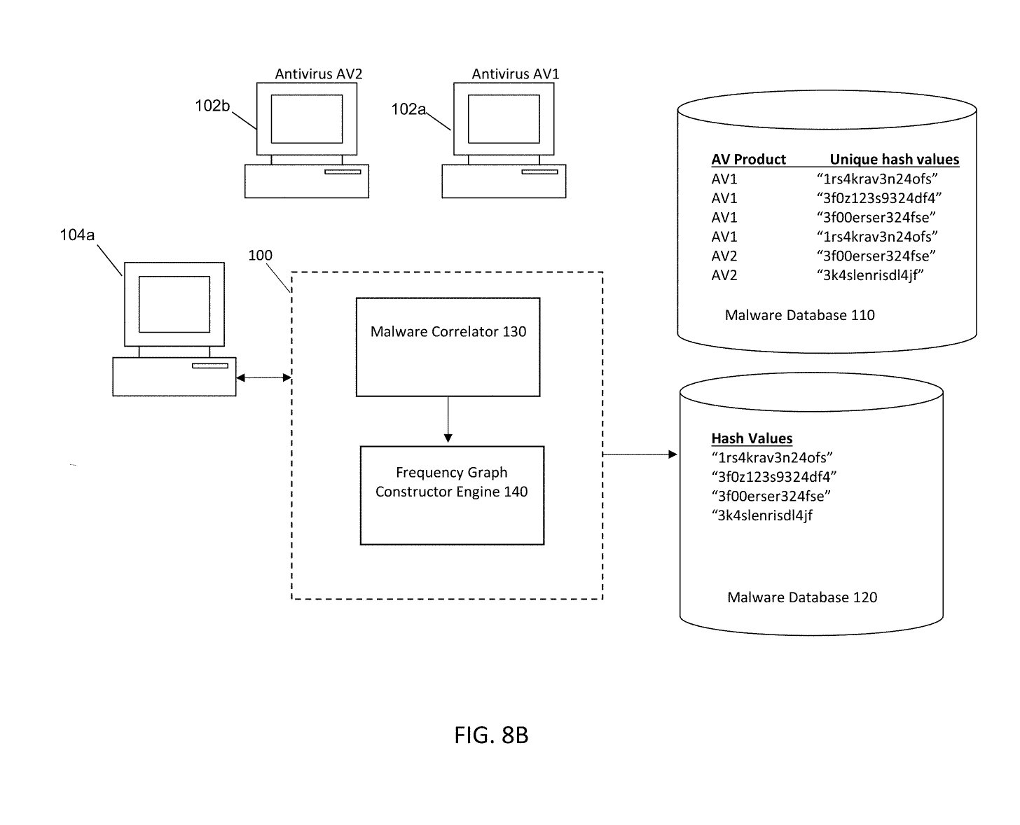

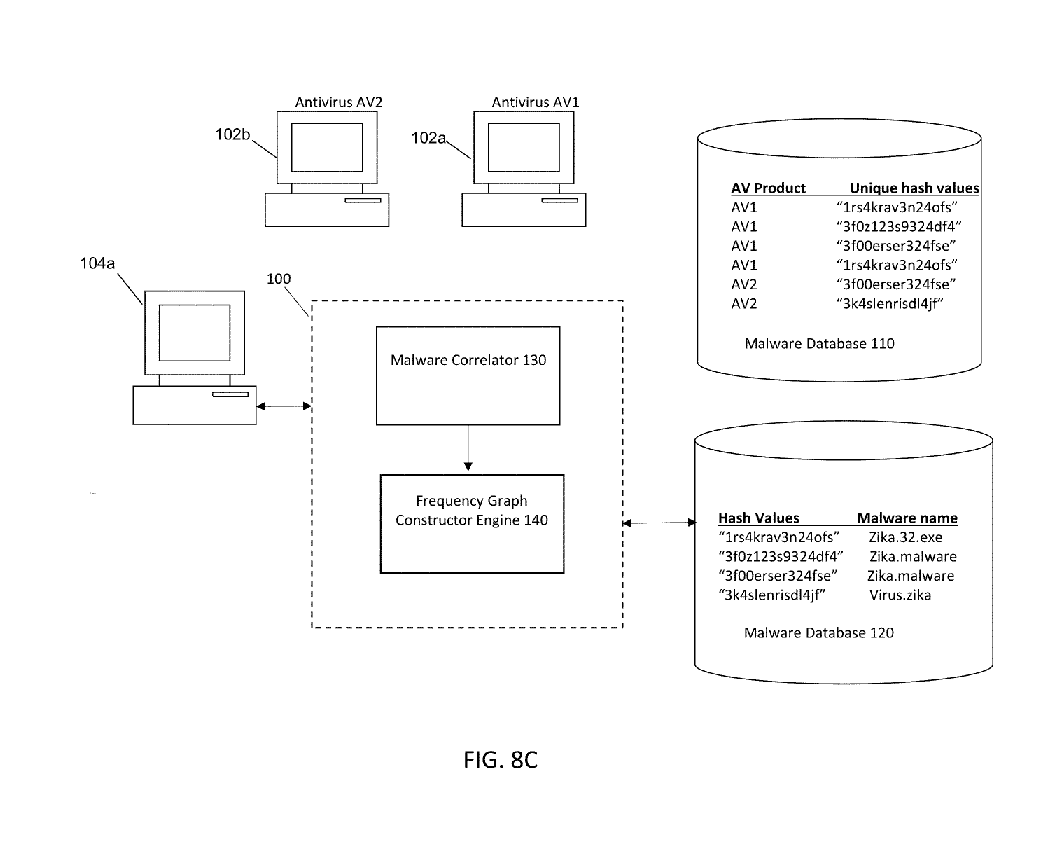

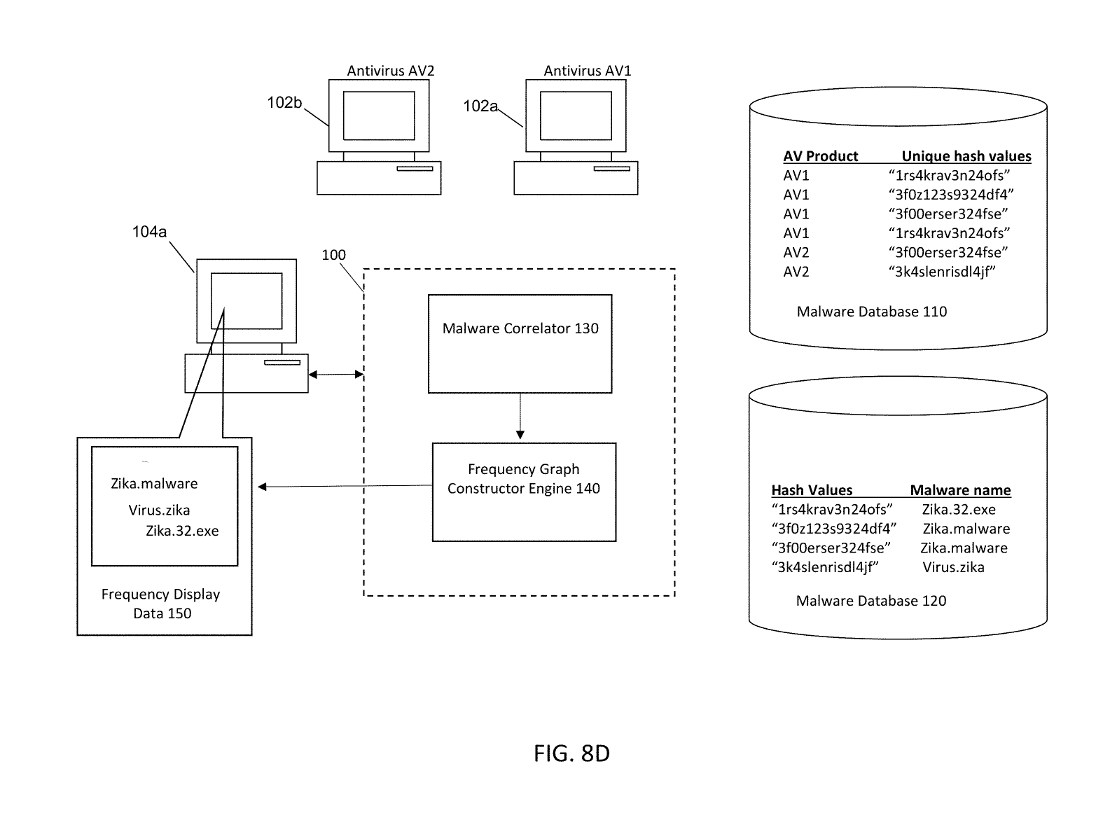

FIGS. 8A-D illustrate diagrams showing components to categorize malware names based on malware network behavior over a given period of time. Here, the interactions between the components and how they interact with one another are shown.

FIG. 8A illustrates collecting a list of unique hash values associated with a malware's network behavior from antivirus vendors who have observed network traffic within a monitored network over a given period of time. The malware network behavior characteristics can be a destination IP, destination domain or peer to peer network behavior. The user computer 104a requests the malware correlator module 100 to query Malware Database 110 for hash values that correspond to the same network behavior. The Malware Database 110 then collects a collection of hash values that correspond to the same network behavior characteristic from antivirus vendors 102a and 102b as shown in Malware Database 110. In some embodiments, the list of unique hash values that correspond to the same network behavior characteristic can be stored into a database in a computer readable storage device.

FIG. 8B illustrates analyzing the collection of hash values to extract a list of unique hash values. As shown in the figure, Malware Correlator 130 has collected 4 unique hash values (e.g., 1rs4krav3n24ofs, 3f0z123s9324df4, 3f00erser324fse, and 3k4slenrisdl4jf) from the and stored them in Malware database 120. In some embodiments, Malware database 110 and Malware database 120 can be the same database. In some embodiments, the multiple virus names can be stored into a database in a computer readable storage device 110. The computer readable storage device could also be implemented as an electronic database system having storage on a persistent and/or non-persistent storage.

FIG. 8C illustrates extracting a list of malware names associated with the collection of malware hashes. The system may include a user computer 104a to request the malware correlator system 100 to query the Malware Database 120 to find malware names associated with the unique hash values. As shown here, the system will query the malware database 120 four separate times to find the malware name because there are four unique hash values. The Malware Correlator 130 will keep track of the separate times the malware database is queried to collect a list of malware names. The Malware Correlator 130 can either store the list of names in the malware correlator 130 or can the names in the malware database 120. In some embodiments, the list of malware names can be stored into a database in a computer readable storage device 110. The computer readable storage device could also be implemented as an electronic database system having storage on a persistent and/or non-persistent storage.

FIG. 8D illustrates constructing a frequency graph of the correlated malware and generating a user interface. The user computer 104 may query the malware correlator system 100 to request the Frequency Graph Constructor Engine 140 to output a Frequency Display Data 150. The Malware Correlator 130 then sends families of malware threats to the Frequency Graph Constructor Engine 140 for constructing a graphical representation of the family of malware threat to display in computer 104a.

The Frequency Graph Constructor Engine 140 will extract a list of malware names for each unique hash value. Next, the Frequency Graph Constructor Engine 140 will receive a request from the user computer 104a to generate a Frequency Display Data 150. The Frequency Graph Constructor Engine 140 will then construct a Frequency Display Data 150 that corresponds to a frequency graph or a “word cloud” graph identifying the most appropriate and commonly used name for the threat. The Frequency Graph Constructor Engine 140 will then send the Frequency Display Data 150 for display to the user on the user computer 104a.

FIG. 9 shows an example of a frequency graph that can be used to display the families of malware names. FIG. 9 illustrates an example of viewing the results of categorizing the malware names.

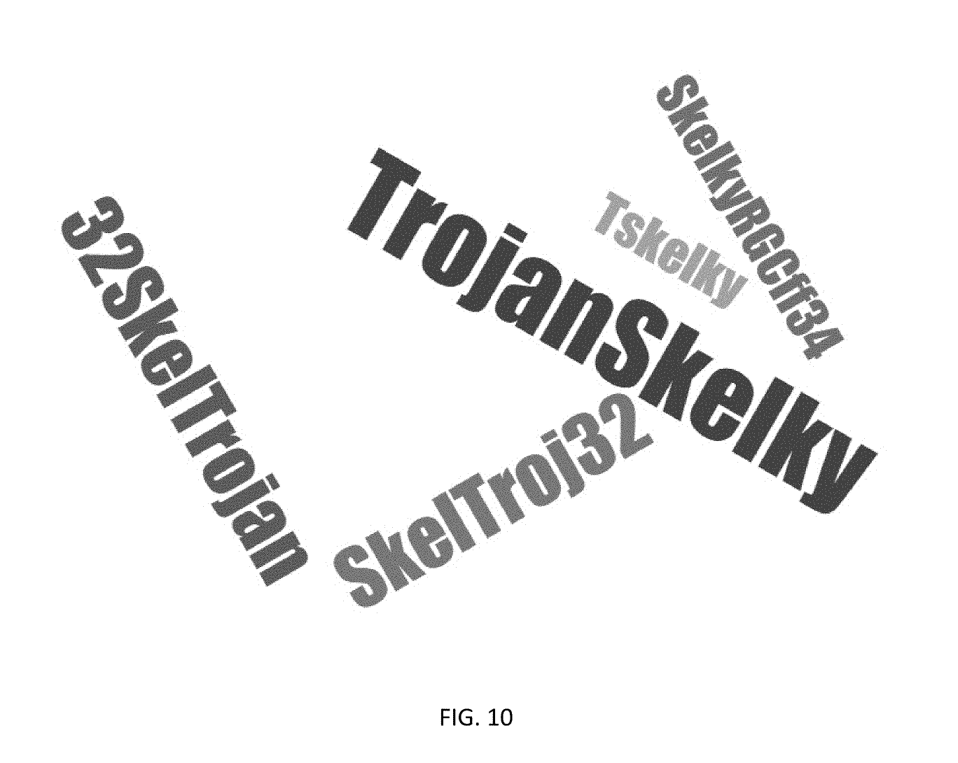

FIG. 10 shows an example of a frequency graph represented as a word cloud that can be used to display the families of malware names. FIG. 10 illustrates an example word cloud figure for viewing the results of categorizing the malware names. The unique malware names may be visualized or highlighted in a way to provide further information about that term. For example, the size of the font for the malware name can be selected to indicate the relative frequency of that term within the content (e.g., where a larger fort size indicates greater frequency for the therm.). Within the interface portion, results are displayed such that the size of the word (e.g., TrojanSkelky) is correlated to the most common name malware name found.

As noted above, the way the terms are displayed in the user interface correlates to the frequency of the malware names. For example, the malware names corresponding to a relatively higher frequency number will have a relatively bigger font size, whereas the terms corresponding to a relatively lower frequency number will have a relatively smaller font size.

### System Architecture Overview

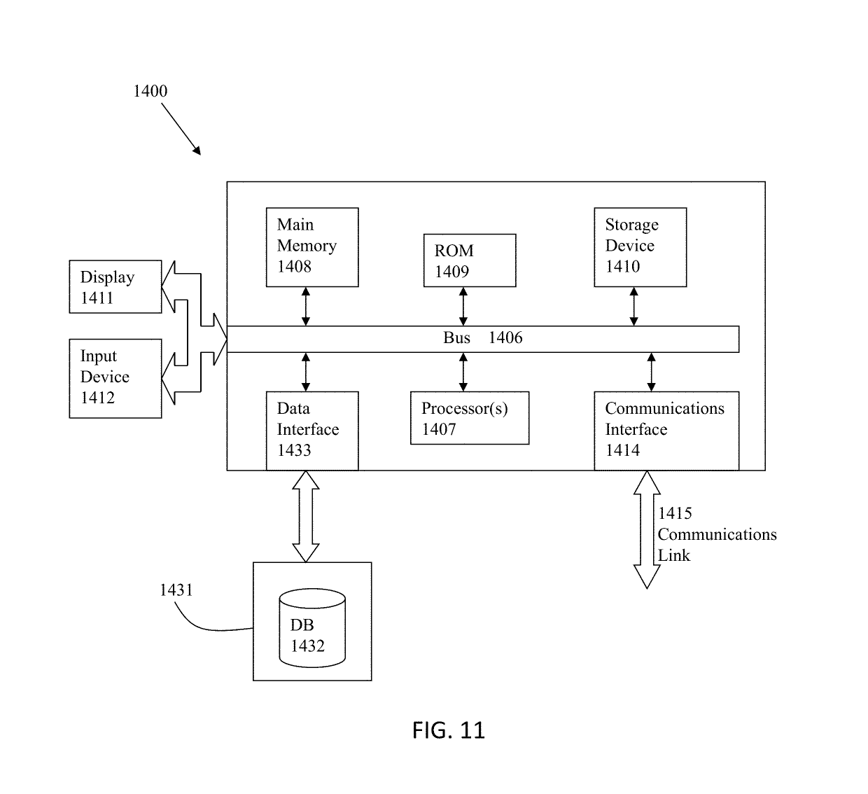

FIG. 11 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any tangible medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408. A data interface 1433 may be provided to interface with medium 1431 having a database 1432 stored therein.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A system for categorizing threat names, comprising:
a malware correlator that analyzes and generates families of malware threats by correlating raw malware data corresponding to a malware virus predicate; and
a frequency graph constructor engine that generates frequency display data corresponding to families of malware threat names.

2. The system of claim 1, further comprising a malware database collecting at least malware names or family of malware names.

3. The system of claim 2, wherein a malware database collects raw malware data from an antivirus product.

4. The system of claim 2, wherein the malware database queries a third party for malware raw data.

5. The system of claim 1, further comprising a malware virus predicate associated with a malware virus network behavior.

6. The system of claim 1, wherein the malware virus predicate corresponds to at least a unique hash value, a secure hash algorithm 1, or a malware name.

7. The system of claim 5, wherein the malware virus network behavior corresponds to at least a IP address destination over a period of time, a domain address destination over a period of time, or a peer to peer network behavior over a period of time.

8. The system of claim 1, wherein a malware database collects a list of unique malware hash values.

9. The system of claim 1, wherein the frequency display data corresponds to a graphical representation of a word cloud.

10. The system of claim 1, further comprising determining whether unique malware hash values have been queried.

11. A computer implemented method for categorizing threats, comprising:
gathering raw data for malware;
querying malware database with a malware virus predicate;
collecting malware data resulting from query;
generating family of malware threats by correlating collected malware data;
constructing a frequency display data of correlated malware; and
generating a user interface.

12. The method of claim 11, further comprising a malware database collecting at least malware names or family of malware names.

13. The method of claim 12, wherein a malware database collects raw malware data from an antivirus product.

14. The method of claim 12, wherein the malware database queries a third party for malware raw data.

15. The method of claim 11, wherein the malware virus predicate corresponds to at least a unique hash value, a secure hash algorithm 1, or a malware name.

16. The method of claim 11, further comprising a malware virus predicate associated with a malware virus network behavior.

17. The method of claim 16, wherein the malware virus network behavior corresponds to at least a IP address destination over a period of time, a domain address destination over a period of time, or a peer to peer network behavior over a period of time.

18. The method of claim 12, wherein a malware database collects a list of unique malware hash values.

19. The method of claim 11, wherein the frequency display data corresponds to a graphical representation of a word cloud.

20. The method of claim 11, further comprising determining whether unique malware hash values have been queried.
